(19) United States
(12) Patent Application Publication
(10) Pub. No.: US 2013/0251033 A1
(43) Pub. Date: Sep. 26, 2013

(54) METHOD OF COMPRESSING VIDEO FRAME USING DUAL OBJECT EXTRACTION AND OBJECT TRAJECTORY INFORMATION IN VIDEO ENCODING AND DECODING PROCESS

(71) Applicant: ELECTRONICS AND TELECOMMUNICATIONS RESEARCH INSTITUTE, (US)

(72) Inventors: Mi Kyong HAN, Daejeon (KR); Eun Jin KO, Daejeon (KR); Hyun Chul KANG, Daejeon (KR); Noh-Sam PARK, Daejeon (KR); Sang Wook PARK, Chungcheongnam-do (KR); Mi Ryong PARK, Gyeonggi-do (KR); Jong Hyun JANG, Daejeon (KR); Kwang Roh PARK, Daejeon (KR)

(73) Assignee: ELECTRONICS AND TELECOMMUNICATIONS RESEARCH INSTITUTE, Daejeon (KR)

(21) Appl. No.: 13/742,698

(22) Filed: Jan. 16, 2013

(30) Foreign Application Priority Data
Mar. 26, 2012 (KR) 10-2012-0030820

(51) Int. Cl. H04N 7/26

(52) U.S. Cl. CPC H04N 19/00587
USPC 375/240.08

(57) ABSTRACT

Disclosed is a method of compressing video frame using dual object extraction and object trajectory information in a video encoding and decoding process, including: segmenting a background and a object from a reference frame in video to extract the object, extracting and encoding motion information of the object based on the object, determining whether a frame is a reference frame based on encoded video in a decoding process, if it is determined that the frame is the reference frame, generating background information of a prediction frame based on the reference frame, and generating the prediction frame by extracting an object of the reference frame and referring to header information to reflect motion information of the object.

### CROSS-REFERENCES TO RELATED APPLICATIONS

The present application claims priority under 35 U.S.C. 119(a) to Korean Application No. 10-2012-0030820, filed on Mar. 26, 2012, in the Korean Intellectual Property Office, which is incorporated herein by reference in its entirety set forth in full.

### BACKGROUND

Exemplary embodiments of the present invention relate to a method of compressing video frames using dual object extraction and object trajectory information in an encoding and decoding process, and more particularly, to a method of compressing video frames using dual object extraction and object trajectory information in an encoding and decoding process capable of extracting video information, motion information, and form variation information on an object in an encoding process, re-extracting an object at a corresponding location using location information of the object generated in the encoding process based on a reference frame in a decoding process, and reconstructing a prediction frame using motion information and form variation information of the extracted object, so as to increase a compression effect according to video characteristics within a P frame or a B frame.

A moving picture compression encoding technology can maximize compression efficiency based on object unit compression in MPEG-4 compared to MPEG-1/2. The MPEG-4 standard mainly targets a common intermediate format (CIF) video or a quarter common intermediate format (QCIF) video rather than a HD-level video at an early stage, but a demand for a more efficient moving picture compression processing technology has been increased with the generalization of a HD-level video and the increased demand for a real-time monitoring system and a video conference, in particular, HD-level mobile moving pictures.

In case of the MPEG-4 or the H.264/AVC standard that is standardized and widely used until now, a procedure for compressing moving pictures may be largely classified into an object based motion compensation inter-frame prediction process, a discrete cosine transform (DCT) process, and an entropy encoding process.

The motion compensation inter-frame prediction method is configured of a method of removing temporal and spatial redundancy in a block unit. Generally, the method of removing temporal redundancy compensates for only a difference value from which redundancy is removed using similarity between video frames to perform prediction, thereby calculating a series of parameters such as a residual frame (hereinafter, referred to as RF), a motion vector (hereinafter, referred to as MV), and the like. The method of removing spatial redundancy is a technology of using a radio frequency as an input and using similarity between neighbor pixels within the RF to remove spatial redundancy elements and outputs quantized transform coefficient values. Thereafter, finally compressed bit streams or compressed files are generated by removing statistical redundancy elements present in data by the quantization and entropy encoding process, such that the compressed data are configured of coded motion vector parameters, coded residual frames, and header information.

Even though only the differential data are transmitted by removing the temporal redundancy in a video field in which a background is fixed and information of moving objects (persons, objects, and the like) is important, like the surveillance camera or the video conference, it is difficult to expect high compression efficiency when a motion of multi object or an object is large.

Therefore, in order to provide the HD-level moving picture information in the surveillance camera, the video conference, or the mobile environment, a need exists for a compression algorithm capable of providing high efficiency while solving problems the deterioration in compression efficiency and image quality.

As the background art related to the present invention, there is Korean Patent Laid-Open No. 10-2000-0039731 (Jul. 5, 2000) (Title of the Invention: Method for Encoding Segmented Motion Pictures and Apparatus Thereof).

The above-mentioned technical configuration is a background art for helping understanding of the present invention and does not mean related arts well known in a technical field to which the present invention pertains.

### SUMMARY

An embodiment of the present invention is directed to a method of compressing video frames using dual object extraction and object trajectory information in an encoding and decoding process capable of providing a higher compression rate than a method of transmitting a difference value and information in a macroblock unit in accordance with the related art, by extracting video information, motion information, and form variation information on an object in an encoding process, extracting an object at a corresponding location using location information of the object based on a reference frame in a decoding process, and reconstructing a prediction frame using motion information and form variation information of the extracted object, so as to increase a compression effect according to video characteristics within a P frame or a B frame.

An embodiment of the present invention relates to a method of compressing video frame using dual object extraction and object trajectory information in a video encoding process including: extracting a start location value and a size of an object and neighbor blocks of the object, and object trajectory information of the object.

The method of compressing video frame may further include extracting form variation information of the object.

The start location value and the size of the object and the neighbor blocks of the object, the object trajectory information of the object, and the form variation information of the object may be extracted corresponding to the number of objects.

The method of compressing video frame may further include after the extracting of the form variation information of the object, when the background information on the neighbor blocks of the object needs to be stored, extracting reference frame information for extracting video information on the neighbor blocks of the object, and the information on the neighbor blocks of the object.

The form variation information of the objects may be stored in header information of the reference frame.

Another embodiment of the present invention relates to a method of compressing video frame using dual object extraction and object trajectory information in a video encoding process, including: determining whether a frame is a reference frame based on encoded video in a decoding process; if it is determined that the frame is the reference frame, generating background information of a prediction frame based on the reference frame; and extracting an object of the reference frame and generating the prediction frame by referring to header information and reflecting motion information of the object.

The method of compressing video frame may further include: when information on neighbor blocks of the object according to the motion of the object is present, referring to the header information to compensate for background errors around the object.

The method of compressing video frame may further include: when form variation information is present in the header information, compensating for the prediction frame according to the form variation information.

The method of compressing video frame may further include: when information of neighbor blocks of the object according to the form variation of the object is present, referring to the header information to compensate for background errors around the object.

The object may be extracted using a location and a size of the object or the neighbor blocks of the object.

The prediction frame may be generated corresponding to the number of objects.

### BRIEF DESCRIPTION OF THE DRAWINGS

The above and other aspects, features and other advantages will be more clearly understood from the following detailed description taken in conjunction with the accompanying drawings, in which:

FIG. 1 is a video image sequence configuration diagram of compressing video frames in accordance with an embodiment of the present invention;

FIG. 2 is a block configuration diagram of an apparatus of compressing video frames using dual object extraction and object trajectory information of video encoding process in accordance with an embodiment of the present invention;

FIG. 3 is a block configuration diagram of an apparatus of compressing video frames using dual object extraction and object trajectory information in a video encoding process in accordance with an embodiment of the present invention;

FIG. 4 is a data structure diagram for a motion and transform operation on objects in a B frame and a P frame in accordance with an embodiment of the present invention;

FIG. 5 is a flow chart of a method of compressing video frames using dual object extraction and object trajectory information in a video encoding process in accordance with an embodiment of the present invention;

FIG. 6 is a diagram illustrating start location values of neighbor blocks of an object and information of a size of an block in accordance with an embodiment of the present invention; and

FIG. 7 is a flow chart of a method of compressing video encoding using dual object extraction and object trajectory information in a video encoding process in accordance with an embodiment of the present invention.

### DESCRIPTION OF SPECIFIC EMBODIMENTS

Hereinafter, a method of compressing video frames using dual object extraction and object trajectory information in an encoding and decoding process in accordance with an embodiment of the present invention will be described with reference to the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

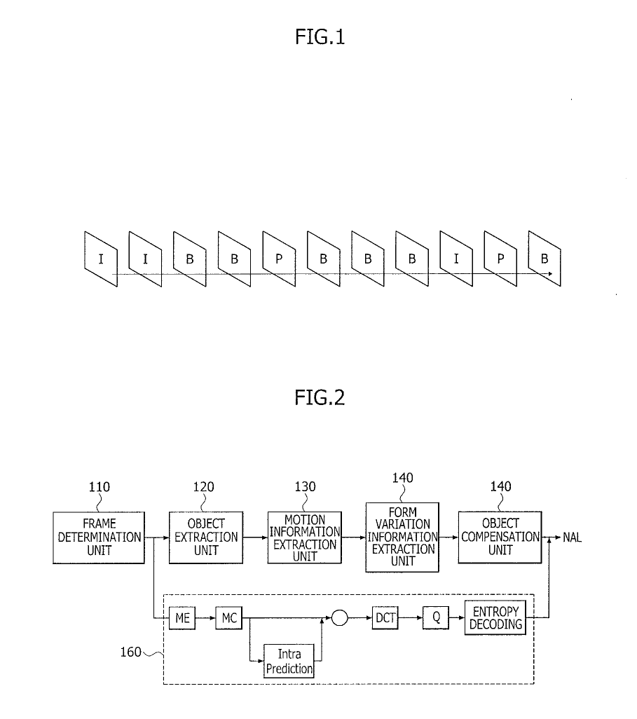

FIG. 1 is a video image sequence configuration diagram of compressing video frames in accordance with an embodiment of the present invention.

As illustrated in FIG. 1, video is configured of an I frame, a P frame, and a B frame.

A compression method is classified into a method applied to the I frame and a method applied to the B frame. The I frame serves as a seed image and is used as a reference before the P frame and the B frame.

In the video, the plurality of P frames may come continuously out and refers to a frame ahead of the P frames Unlike the P frame, the B frame may bidirectionally refer to the frames that are present before and after the B frame.

FIG. 2 is a block configuration diagram of an apparatus of compressing video frames using dual object extraction and object trajectory information of video encoding process in accordance with an embodiment of the present invention.

An apparatus of compressing video frames using dual object extraction and object trajectory information in a video encoding process in accordance with an embodiment of the present invention may include a frame determination unit 110, an object extraction unit 120, a motion information extraction unit 130, a form variation information extraction unit 140, and an object compensation unit 150. Further, the apparatus of compressing video frames includes an encoding unit 160 that performs a general encoding process on the I frame.

The frame determination unit 110 reads a current frame and determines a frame type according to characteristics of the frame.

At the time of determining the frame type, the frame is determined as the I frame when the frame is an initial scene and the frame is determined as the P frame or the B frame when the frame is not the initial scene. On the other hand, when the frame is the P frame or the B frame, the object extraction unit 120 extracts the object from the reference frame.

The motion information extraction unit 130 extracts the motion information of the object based on the object extracted from the reference frame when the object is extracted from the reference frame by the object extraction unit 120.

The form variation information extraction unit 140 confirms when the frame is changed based on the object extracted from the reference frame to extract a function for variation. In this case, the object compensation unit 150 compensates for errors on the object that may occur by the variation of the object.

Meanwhile, when the frame determined by the frame determination unit 110 is the I frame, the encoding unit 160 performs a general compression process. That is, motion estimation (ME) and motion compensation (MC) are performed and if necessary, after performing intra prediction, a discrete cosine transform (DCT) process and a quantization (Q) process are performed and an entropy coding process is performed, such that data of a network adaptation layer (NAL) format that is transmittable compression bit strings are output.

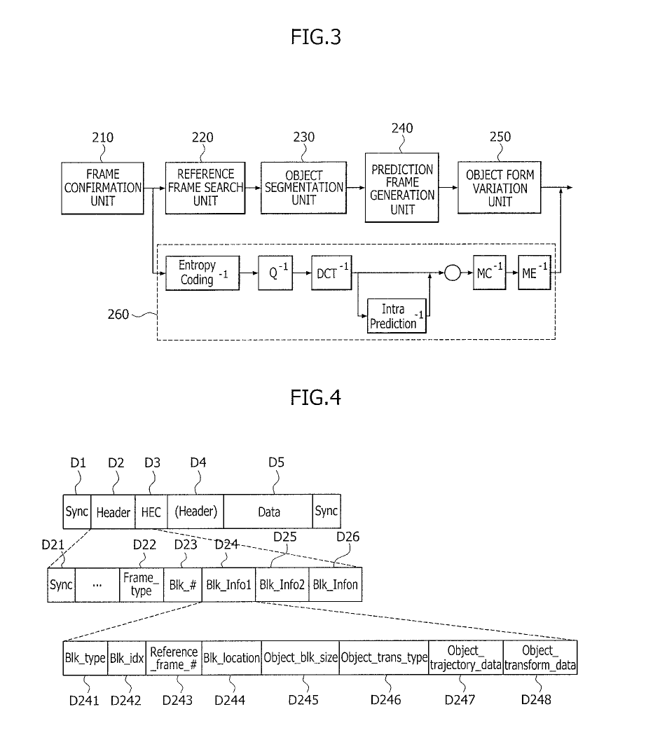

FIG. 3 is a block configuration diagram of an apparatus of compressing video frames using dual object extraction and object trajectory information in a video encoding process in accordance with an embodiment of the present invention.

As illustrated in FIG. 3, an apparatus of compressing video frames using dual object extraction and object trajectory information in a video encoding process in accordance with an embodiment of the present invention may include a frame confirmation unit 210, a reference frame search unit 220, an object segmentation unit 230, a motion reflection unit, and an object form variation unit 250. Further, the apparatus of compressing video frames includes a decoding unit 260 that performs a general decoding process on the I frame.

The frame confirmation unit 210 reads data of a bit stream type output in the compression encoding process to detect characteristics of the frame.

The reference frame search unit 220 refers to header information to search the reference frames when the detected frame is the P frame or the B frame.

The object segmentation unit 230 refers to the location and size of the object included in the header information in the reference frame searched in the reference frame search unit 220 to extract the object.

The prediction frame generation unit 240 reflects the motion on the object based on the extracted object in the object segmentation unit 230 to generate the prediction frame.

The object form variation unit 250 performs the form variation of the object to perform the compensation operation of the prediction frame when the form variation of the object is required in the prediction frame generated by the prediction frame generation unit 240.

The encoding unit 260 performs a general decoding process when the frame is the I frame according to the results of detecting the frame characteristics in the foregoing frame confirmation unit 210. That is, the video is decoded by performing entropy decoding (entropy coding⁻¹), dequantization (Q⁻¹), inverse DCT (DCT⁻¹), intra prediction (intra prediction⁻¹), motion prediction (MC⁻¹), and motion compensation (ME⁻¹).

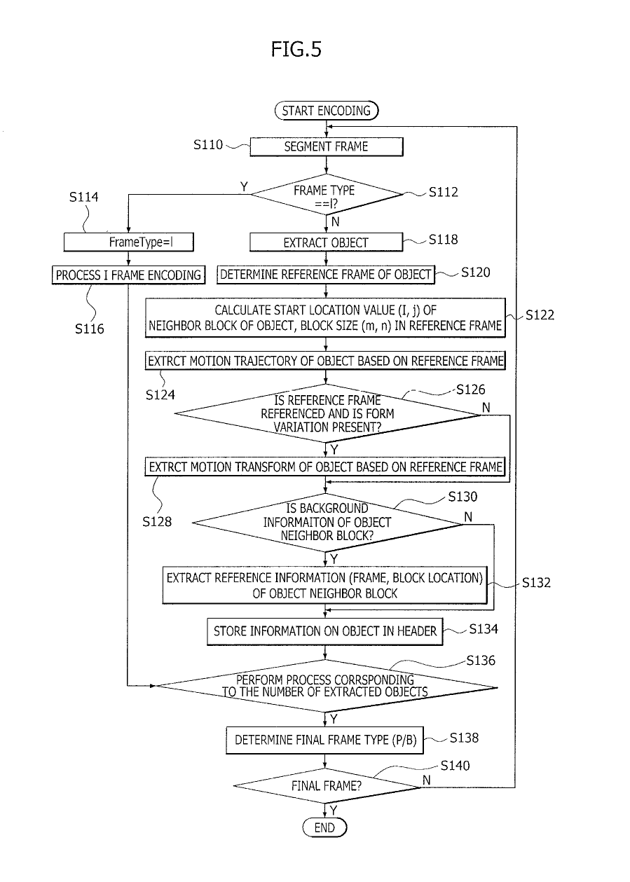

FIG. 4 is a data structure diagram for a motion and transform operation on an object in a B frame and a P frame in accordance with an embodiment of the present invention.

The header information includes information for motion and transform application on the object and as illustrated in FIG. 4, includes sync D1 for synchronization at the time of bitstream transmission similarly to H.264, header D2 including information of the object and the frame, a header extension code (HEC) flag D3 for error recovery support of the header D2 during the decoding process, and a data field D5 that is a header copy information D4 for the error recovery support and data information.

The Header D2 includes a sequence parameter set D21, and the like, including information of the encoding of the overall sequence such as profile and level of the video, and the like, included in the H.264 for compatibility with the H.264 format. In addition, the Header D2 includes a Frame_type D22 for discriminating whether the corresponding frame is the I frame or the P frame or the B frame, Blk_# D23 that is the information of the extracted object and the number of neighbor blocks of the object, and Blk_Info (D24) including the information of the corresponding object and block.

The Blk_Info D24 includes Blk_type D241 for discriminating whether the corresponding block information is the information of the object or the information on the neighbor blocks of the object, Blk_idx D242 that is an index number of the corresponding object or block, Reference_frame_# D243 that is number information of the reference frame for extracting the corresponding object or block, Blk_location that is location information within the referenced frame of the object or the block, Object_blk_size D245 that is size information on the neighbor blocks or the background block of the object, Object_trans_type D246 that is information for indicating whether the form variation information of the object is additionally included, Object_trajectory data D247 that is motion trajectory information of the object, and Object_transform_data information D248 that is the form variation information of the object.

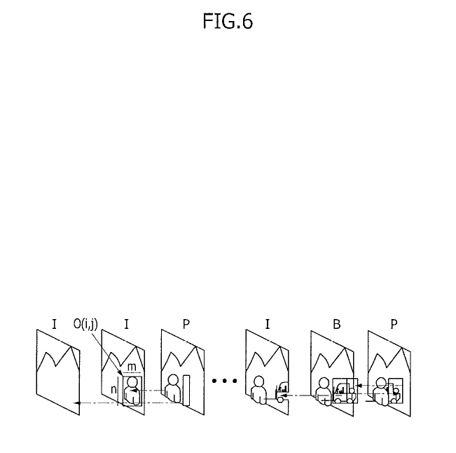

FIG. 5 is a flow chart of a method of compressing video frames using dual object extraction and object trajectory information in a video encoding process in accordance with an embodiment of the present invention and FIG. 6 is a diagram illustrating start location values of neighbor blocks of object and information of a size of block in accordance with an embodiment of the present invention.

As illustrated in FIG. 5, the frame determination unit 110 discriminates whether the corresponding frame is processed with the I frame and the P/B frames A102 and A103 when the encoding starts (S110). If it is determined that the corresponding frame is processed with the I frame (S112), the frame type is set to I (S114). In this case, the encoding unit 160 performs the encoding processing by the encoding processing method of the I frame of the general H.264 (S116).

On the other hand, when the corresponding frame is not the I frame, the object extraction unit 120 extracts the object from the corresponding frame (S118) and searches the reference frame in the previous or subsequent frame for the corresponding object (S120).

Next, the motion information extraction unit 130 calculates a start location value (i, j) and a size (m, n) of the corresponding object within the reference frame or the neighbor blocks of the object illustrated in FIG. 6 (S122) and extracts the motion trajectory information of the object based on the reference frame (S124).

In this case, when the object trajectory based on the reference frame and the form variation of the object are required (S126), the object form variation unit 250 extracts the information for the form variation of the current frame object based on the object form of the reference frame (S128).

In this case, when the background information on the neighbor blocks of the object needs to be stored since the background information around the object has the change compared to the previous frame due to the object (S130), the object compensation unit 150 extracts the reference frame information and the location information of the background block for extracting the video information on the neighbor blocks of the object (S132) and then stores the information of the object and the overall information on the neighbor blocks of the object in the header information (S134).

When the additional information of the object is required according to whether the overall information corresponding to the number of extracted objects is extracted (S136), a series of processes S122 to S134 for extracting the object information are performed again.

In this process, when the overall information corresponding to the number of extracted objects is extracted, the type of the final frame is determined as the P frame or the B frame according to the temporal sequential information of the reference frame (S138). The compression processing ends and otherwise, the series of processes S110 to S138 are performed again, according to whether the performed frame is the final frame of the compression target file (S140).

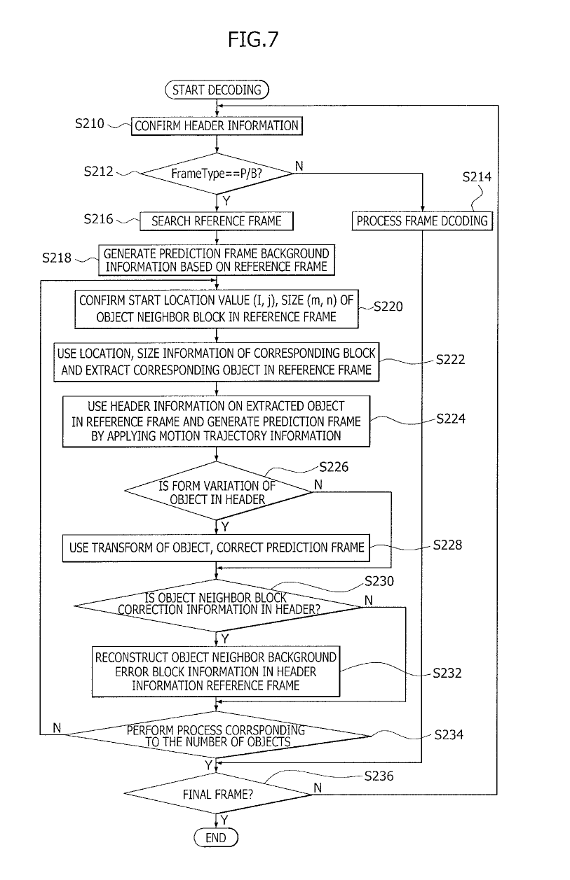

FIG. 7 is a flow chart of a method of compressing video encoding using dual object extraction and object trajectory information in a video encoding process in accordance with an embodiment of the present invention.

As illustrated in FIG. 7, the frame confirmation unit 210 confirms the header information (S210) to discriminate whether the corresponding frame is processed with the I frame, or the P frame or the B frame when the decoding starts (S212).

When the corresponding frame is processed with the I frame, the decoding unit 260 performs the I frame decoding processing of the general H.264 (S214).

On the other hand, when the frame type is the P frame or the B frame, the reference frame search unit 220 searches the corresponding object or the reference frame of the neighbor blocks of the object (S216).

The object segmentation unit 230 generates the background information of the prediction frames based on the reference frame searched in the reference frame search unit 220 (S218) and confirms the location (i, j) and the size (m, n) of the object or the neighbor blocks of the object in the reference frame (S220) to extract the corresponding object at the location of the corresponding block within the reference frame (S222).

The prediction frame generation unit 240 refers to the header information on the extracted object in the object segmentation unit 230 to reflect the motion information of the object using the trajectory information of the object, thereby generating the prediction frame (S224).

In addition, when the form variation information of the object is included in the header information (S226), the object form variation unit 250 uses the form variation information of the object, for example, the transform information to compensate the prediction frame (S228). Further, for compensating for the background information of the neighbor blocks of the object due to the motion or the form variation of the object based on the reference video, when the information on the neighbor blocks is present (S230), the neighbor blocks of the corresponding object is reconstructed by compensating for the background errors around the object by referring to the header information.

A series of processes (S222 to S232) is performed again according to whether the frame compensating operation is performed according to the number of extracted objects within the prediction frame (S234).

Next, when the prediction frame compensation of the object included in the header information and the neighbor blocks of the object is completed, it is confirmed whether the frame is a final frame of the video file (S236) and if it is determined that the frame is a final frame, the decoding process ends and if it is determined that the frame is not a final frame, the series of processes (S210 to S236) is performed again for the decoding process for the next frame.

In accordance with the embodiments of the present invention, it is possible to provide the high compression effect by transmitting only the information of the object present in the reference frame and the motion and motion variation information of the object so as to reduce the file size of the encoding target video.

Further, in accordance with the embodiments of the present invention, it is possible to provide the higher compression effect of the video in which the background is fixed and the moving object is easily extracted, like the surveillance camera or the video conference.

Although the embodiments of the present invention have been described in detail, they are only examples. It will be appreciated by those skilled in the art that various modifications and equivalent other embodiments are possible from the present invention. Accordingly, the actual technical protection scope of the present invention must be determined by the spirit of the appended claims.

What is claimed is:

1. A method of compressing video frame using dual object extraction and object trajectory information in a video encoding process, comprising:
segmenting a background and an object from a reference frame in video to extract the object; and
extracting a start location values and a size of the object and neighbor blocks of the object and object trajectory information of the object.

2. The method of claim 1, further comprising: extracting form variation information of the object.

3. The method of claim 2, wherein the start location value and the size of the object and the neighbor blocks of the object, the object trajectory information of the object, and the form variation information of the object are extracted corresponding to the number of objects.

4. The method of claim 2, further comprising: after the extracting of the form variation information of the object, when the background information on the neighbor blocks of the object needs to be stored, extracting reference frame information for extracting video information on the neighbor blocks of the object, and the information on the neighbor blocks of the object.

5. The method of claim 2, wherein the form variation information of the object is stored in header information of the reference frame.

6. A method of compressing video frame using dual object extraction and object trajectory information in a video encoding process, comprising:
determining whether a frame is a reference frame based on encoded video in a decoding process;
if it is determined that the frame is the reference frame, generating background information of a prediction frame based on the reference frame; and
extracting an object of the reference frame and generating the prediction frame by referring to header information and reflecting motion information of the object.

7. The method of claim 6, further comprising: when information of neighbor blocks of the object due to the motion of the object is present, referring to the header information to compensate for background errors around the object.

8. The method of claim 7, further comprising: when form variation information is present in the header information, compensating for the prediction frame according to the form variation information.

9. The method of claim 8, further comprising: when information of neighbor blocks of the object due to the form variation of the object is present, referring to the header information to compensate for background errors around the object.

10. The method of claim 6, wherein the object is extracted using a location and a size of the object or the neighbor blocks of the object.

11. The method of claim 6, wherein the prediction frame is generated corresponding to the number of objects.
